(19) United States
(12) Patent Application Publication
(10) Pub. No.: US 2019/0305955 A1
(43) Pub. Date: Oct. 3, 2019

(54) PUSH NOTIFICATION AUTHENTICATION

(71) Applicant: CA, Inc., Islandia, NY (US)

(72) Inventors: Deepak Kumar Verma, Hyderabad (IN); Nagesh Akkera, Hyderabad (IN)

(21) Appl. No.: 15/937,389

(22) Filed: Mar. 27, 2018

(51) Int. Cl. H04L 9/32; H04L 29/06; H04L 9/08

(52) U.S. Cl. CPC H04L 9/3228; H04L 63/102; H04L 2463/082; H04L 63/0853; H04L 9/0825; H04L 63/0838

(57) ABSTRACT

Provided is a process, including: retrieving an identifier of a mobile computing device associated with a user; causing a push notification to be sent to the mobile computing device, wherein the push notification comprises or causes the mobile computing device to retrieve an authentication-session specific value; forming an authentication-session record that associates the authentication-session specific value with the mobile computing device; receiving an identifier that identifies the mobile computing device, and a cryptographically signed value demonstrating possession of both the authentication-session specific value and a private cryptographic key; determining to authenticate the user by selecting, the authentication-session record from among a plurality of authentication-session records; and determining, based on both a public cryptographic key of a profile of the user and the authentication-session specific value, that the received cryptographically signed value correctly demonstrates possession of both the authentication-session specific value and the private cryptographic key.

### CROSS-REFERENCE TO RELATED APPLICATIONS

No cross reference is presented at this time.

### BACKGROUND

### 1. Field

The present disclosure relates generally to cybersecurity and, more specifically, to push notification-based multi-factor authentication for distributed systems.

### 2. Description of the Related Art

Cross-device authentication is often used to authenticate users attempting to access resources of network-accessible applications with client computing devices. Often, when a user seeks to log-onto an online service with their laptop or other client computing device, an authentication request is received, and a push notification is sent to a mobile computing device associated with the user attempting to access resources. The push notification may be sent by text message to a mobile computing device registered to a phone number previously supplied by the user, for example. The push notification typically includes a one time password (OTP), which the user is asked to supply via his or her client computing device to demonstrate possession of the mobile computing device. The user may be authenticated and allowed to access the resources of the network accessible application with his or her client computing device responsive to the OTP supplied via the client computing device matching the OTP sent in the push notification to the mobile device. In some implementations, the OTP is simply attached to a return communication sent from a user's mobile device and verified responsive to the OTP supplied via the mobile device matching the OTP sent in the push notification to the mobile device.

### SUMMARY

The following is a non-exhaustive listing of some aspects of the present techniques. These and other aspects are described in the following disclosure.

Some aspects include a process that includes: receiving, with one or more processors of an authentication system, via a network, a request to authenticate a user attempting to access resources of a network-accessible application with a client computing device; receiving, with one or more processors of the authentication system, from the client computing device, via the network, a user identifier that is associated with the request, wherein: the user identifier identifies a profile of the user, in the profile, the user is associated with both a mobile computing device and a public cryptographic key of an asymmetric cryptographic process, and the mobile computing device stores a record by which the mobile computing device accesses a private cryptographic key corresponding to the public cryptographic key upon receiving a credential from the user; in response to receiving the request, accessing, with one or more processors of the authentication system, the profile of the user based on the user identifier and retrieving an identifier of the mobile computing device; causing, with one or more processors of the authentication system, based on the identifier of the mobile computing device, a push notification to be sent to the mobile computing device, wherein: the push notification comprises, or causes the mobile computing device to retrieve from the authentication system, an authentication-session specific value with greater than 32 bits of entropy; forming, in memory, with one or more processors of the authentication system, an authentication-session record that associates the authentication-session specific value with the mobile computing device; receiving, with one or more processors of the authentication system, from the mobile computing device both: an identifier that identifies the mobile computing device or an authentication session in which the push notification was sent, and a cryptographically signed value demonstrating possession of both the authentication-session specific value and the private cryptographic key; determining, with one or more processors of the authentication system, to authenticate the user by: selecting, based on the identifier that identifies the mobile computing device or an authentication session in which the push notification was sent, the authentication-session record from among a plurality of authentication-session records, at least some of which correspond to other authentication sessions with other users; accessing, from the selected authentication-session record, the authentication-session specific value or value based thereon with greater than 32 bits of entropy; determining, based on both the public cryptographic key of the profile of the user and the authentication-session specific value or value based thereon, that the received cryptographically signed value correctly demonstrates possession of both the authentication-session specific value and the private cryptographic key; and in response to the determination to authenticate the user, causing, with one or more processors of the authentication system, a message to be sent to the network-accessible application that causes the network-accessible application to grant access to the resources to the client computing device.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a physical and logical architecture block diagram showing an example of a push notification authentication computing environment in accordance with some embodiments of the present techniques;

FIG. 2 is a flowchart illustrating a practical use case that includes operations of the authentication process described with respect to the computing environment shown in FIG. 1.

FIG. 3 is a multi-entity flowchart showing communications that may be passed when authenticating a user in accordance with some embodiments of the present techniques; and

FIG. 4 shows an example of a computer system by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of cybersecurity and human-computer interaction. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Many existing cross-device authentication techniques are expected to become more vulnerable to attack in the future as the amount of computing resources available for brute force attacks increase. Often, a user supplies credentials to a website, and then the web server causes a one time password (OTP) or other codes to be sent in a push notification to the user's mobile device, which is then entered back into the website by the user to authenticate the user with two factors: knowledge of the supplied credential, and possession of the mobile device. In some systems, the OTP is simply attached to a push notification sent to a user's mobile device and verified by the prior art systems when the user responds to the notification. These approaches may become vulnerable susceptible to man-in-the-middle attacks (sending a counterfeit webform requesting the user's credentials upon brute-forcing a certificate authority's private key) combined with attacks in which a user's cell phone number is transferred by an adversary to a device they control (e.g., by a social engineering attack on a cell phone service provider). None of which is to suggest that use of OTP's, or any other subject matter herein, is disclaimed, as such approaches may be augmented with the present techniques.

Further, in some systems, push notifications associated with individual applications are generated by individual application servers. This means each individual application executed on a mobile computing device (for example) may be required to register a current IP address with a different remote server (e.g., a different application server). This may waste battery power in the mobile computing device and have other disadvantages. None of which is to suggest that use of app-by-app IP registration, or any other subject matter herein, is disclaimed, as such approaches may be augmented with the present techniques.

To mitigate some of these issues, and in some embodiments all of these issues, some embodiments described herein strengthen the security of push notification authentication operations using relatively high-entropy (e.g., of greater than 32 bits of entropy) authentication-session specific values (e.g., random strings) combined with public key infrastructure (PKI) and/or (which is not to suggest that the term “or” is used exclusively elsewhere) other features. For example, in some embodiments, a request to authenticate a user attempting to access resources of a network-accessible application with a client computing device may be received along with a user identifier that is associated with the request. The user identifier may identify a profile of the user. In the profile, the user may be associated with both a mobile computing device and a public cryptographic key of an asymmetric cryptographic process. The mobile computing device may store a record by which the mobile computing device accesses a private cryptographic camouflaged key corresponding to the public cryptographic key upon receiving a credential (e.g., a personal identification number, a biometric identifier such as a finger print, and/or other credentials) from the user. Responsive to receiving the authentication request at an authentication system, the user profile may be identified from an identifier in the request, the user profile may be identified with the user identifier, the mobile device may be identified from the profile, and a push notification may be sent to the mobile computing device of the user. The push notification may include (or in some cases cause the mobile computing device to retrieve), an authentication-session specific value (e.g., a random value, such as a random string generated with a pseudorandom process). The authentication-session specific value may be associated with the mobile computing device in an authentication-session record stored at the authentication system. The mobile computing device may, in return, communicate both an identifier that identifies the mobile computing device or an authentication session in which the push notification was sent, and a cryptographically signed value demonstrating possession of both the authentication-session specific value and the private cryptographic key. The user may be authenticated by, among other operations, determining, based on both the public cryptographic key of the profile of the user and the authentication-session specific value, that the received cryptographically signed value correctly demonstrates possession of both the authentication-session specific value, the private cryptographic camouflage key, and the ability to de-camouflage the cryptographic camouflaged key.

Some embodiments may provide a variety of related features, such as:
a. At the mobile device, camouflaging and/or otherwise masking the private cryptographic key in the memory of the mobile computing device, thus making the private cryptographic key inaccessible to processes probing persistent storage of a mobile device without the user credential;
b. At the mobile device, unmasking the private cryptographic key based on both the credential from the user and the record by which the mobile computing device accesses the private cryptographic key;
c. Computing a cryptographic hash value based on the authentication-session specific value; and encrypting the cryptographic hash value with the private cryptographic key to produce a ciphertext;
d. Determining that the received cryptographically signed value correctly demonstrates possession of both the authentication-session specific value, the private cryptographic camouflaged key and the ability to de-camouflage by decrypting the ciphertext with the public cryptographic key to access the cryptographic hash value computed by the mobile computing device; and computing a cryptographic hash of the sent authentication-session specific value with the authentication system and determining a resulting cryptographic hash output matches the accessed cryptographic hash value computed by the mobile computing device;
e. Not providing an indication to the user of whether the credential from the user is correct before causing the message to be sent from the mobile computing device; incrementing a count of failed authentication attempts, determining whether the count exceeds a threshold, and denying authentication regardless of whether a correct credential from the user is provided after determining that the count exceeds a threshold; and
f. Causing a push notification to be sent to the mobile computing device via a remote push notification service, where a native authentication application executing on the mobile computing device has previously registered the mobile computing device with the push notification service; and the message is sent with an authentication token by which the push notification service determines whether the message is authorized.

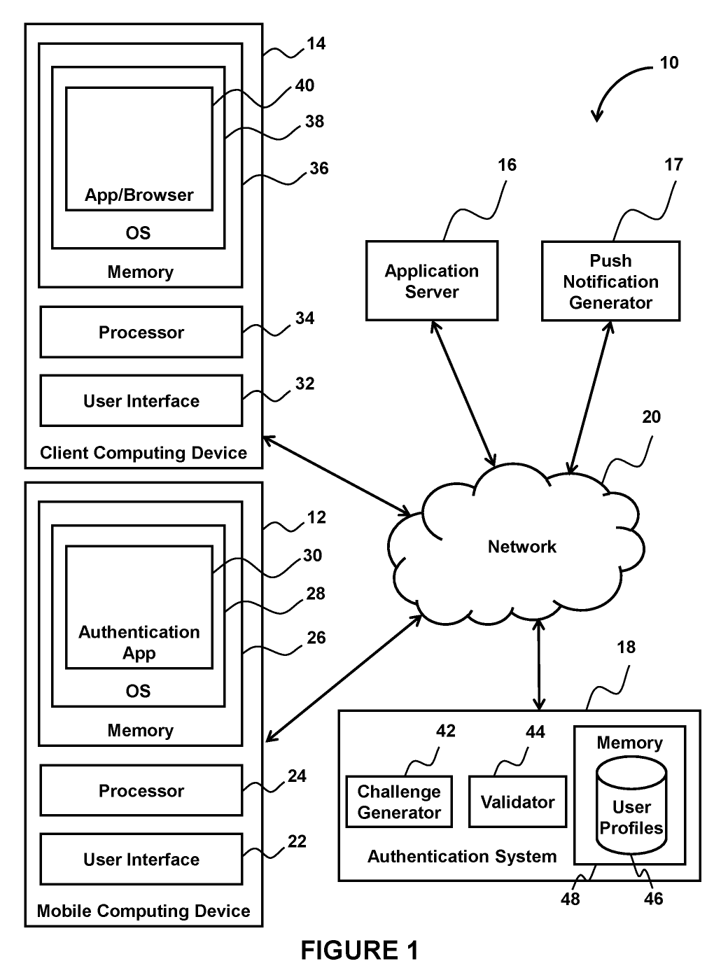

In some embodiments, some, and in some cases all of the above-described features may be implemented in a computing environment 10 shown in FIG. 1. It should be emphasized, though, that not all embodiments include all of the above-described features, afford all of the above-described benefits, or partially or fully mitigate all of the above-describe problems with traditional techniques, which is not to suggest that any other description herein is limiting. Rather, multiple, independently useful techniques are described, with various engineering and cost trade-offs, and some embodiments may implement some of those techniques while not implementing others.

As shown in FIG. 1, some embodiments may include a pair of computing devices of a user, in this case a mobile computing device 12 and a client computing device 14, along with one or more application servers 16 that may host remote resources the user seeks to access with the client computing device 14. Computing environment 10 may further include an authentication system 18 that determines whether to authenticate users seeking access on behalf of the application servers 16 by interfacing with the user computing devices 12 and 14, in accordance with the techniques described below, and a push notification generator 17 configured to push notifications to mobile computing device 12 responsive to instructions from the authentication system 18.

A single pair of user computing devices 12 and 14 for an individual user are shown, but embodiments are consistent with substantially more pairs of computing devices, and may include in commercial implementations more than 10, more than 100, or more than 1000 pairs of computing devices concurrently seeking authentication for respective users, in some cases among a user to base exceeding 1 million, 10 million, or 100 million users. Similarly, one application server 16 is shown by way of example, but some embodiments may include a plurality of application servers 16, which may be integrated with the authentication system 18 or may be distinct services accessible via a different domain. Some embodiments may include substantially more application servers 16, for instance more than 10, or more than 50 different application servers for more than 10, or more than 50 different web applications or application program interfaces at distinct web domains and data centers. In some embodiments, the illustrated components may communicate with one another via one or more networks 20, such as the Internet, various local area networks, cellular networks, wireless area networks, and the like.

In some embodiments, the mobile computing device 12 may be a smart phone, a wearable computing device, a tablet computer, a laptop computer, a smartwatch, a head mounted display, or the like. In some cases, a non-mobile computing device may serve the role of the mobile computing device 12. In some embodiments, the mobile computing device 12 may include an onboard power supply, such as a battery and one or more radios by which wireless network access is provided to the network 20. In some embodiments, the mobile computing device 12 includes a user interface 22, a processor 24, and memory 26 storing program code of an operating system 28 and a native authentication application 30, in some cases among various other native applications. In some embodiments, the processor 24 may coordinate the operation of the other components illustrated and execute program instructions stored in memory 26, including executing the operating system 28 in the native application 30, in some cases interfacing via the native application 30 and the various illustrative hardware may be through various application program interfaces provided by the operating system 28. In some embodiments, the processor 24 is a central processing unit. In some embodiments, the processor 24 may execute program code of the native application 30 that causes the native application to provide the functionality described below, which is attributed to a mobile computing device.

In some embodiments, the authentication application 30 may interface with a secure element or other secure coprocessor. For example, the authentication application 30 may be configured such that an isolated processor of device 12 communicates with the authentication application 30 through a narrow channel, for instance via interrupts.

The client computing device 14 may be separate and distinct from mobile computing device 12. In some embodiments, the client computing device 14 may be a laptop computer, a desktop computer, a tablet computer, and/or other user computing devices. In some embodiments, the client computing device 14 may be a second mobile computing device. In some embodiments, the client computing device 14 may include a user interface 32, a processor 34, and memory 36, storing operating system 38 and a web browser and/or another native authentication application 40 configured to access a remote API for which authentication is sought. In some embodiments, the operating system 38 may be a desktop or a mobile operating system, which in some cases may be a different operating system from the operating system 28 of the mobile computing device 12. In some embodiments, a user may have navigated the web browser or native application 40, and supplied user identifiers and credentials in accordance with this process, described below, before engaging the mobile computing device 12.

In some embodiments, the application server 16 may be one or more servers, for instance behind load balancers, at one or more web domains at which various web applications or application program interfaces of native applications are accessible. In some embodiments, the application server 16 may be configured to send a view of a user interface to a client computing device 14 after receiving a request to access resources, such as a web application or other application program interface. In some embodiments, the sent user interface view may include web browser instructions, resources, scripting language commands, and the like that are executed by a web browser and/or native application 40 to form at least a portion of the user interface 32 on the client computing device 14 and cause the user interface view sent by the application server 16 to be displayed on user interface 32. In some embodiments, the user interface view may include inputs, such as text box inputs, by which a user supplies a user identifier (e.g., a user name), a knowledge factor credential (e.g., a password), and/or other information. In some cases one or both of these values (the user identifier and the knowledge factor credential) may be retrieved from a persistent client-side data repository, like a cookie, local storage object, SQL light database, or the like. For instance, the retrieval may be implemented by executing a corresponding portion of sent scripting language commands that retrieve these values and send them back to the application server 16. In some cases, upon a client computing device 14 requesting access resources, the application server 16 may redirect the web browser to the authentication system 18, or embed content from authentication system 18, that includes such a user interface view. In some embodiments, the redirect command may include in a uniform resource identifier of the application server 16, among each of the application servers 16 serviced by the authentication server 18, along with a unique identifier. The unique identifier may track an authentication session such that subsequent interactions may be tied back to the application server 16 by the authentication system 18. The user's computing device may be redirected back to the appropriate application server 16 upon authentication (described below) by the authentication system 18, for instance by retrieving a uniform resource identifier of the appropriate application server 16 based upon the identifier in the redirect command sent to the web browser 40. This redirect command may cause the web browser 40 to execute a get request to the application server 18 that conveys that identifier. In some cases, upon authenticating the user, the web browser 40 may then be redirected again, for instance, sent another URL selected based upon the identifier of the application server 16. In some embodiments, the application server 16 may communicate directly with the authentication system 18, for instance via a back channel communication via the network 20 that does not pass through the web browser 40. Thus, in some cases, the application server 16 may embed content sent to the web browser 40 or pass through content retrieved from the web browser 40, such as user credentials and identifiers sent to the authentication system 18. In some embodiments, the authentication system 18 may send a result of authentication to the application server 16 via this back channel communication.

The push notification generator 17 may be a remote push notification service, such as the Firebase Cloud Messaging™ service of Google Inc. of Mountainview Calif. or Apple Push Notification service (APNs) of Apple, Inc. of Cupertino, Calif. In some embodiments, push notification generator 17 may provide push notifications for more than 10, 100, or 1000 different native applications by more than 10, 100, or 1000 different native-application developers. In some embodiments, the native authentication application 30 executing on the mobile computing device 12 may have previously registered the mobile computing device 12 with the push notification generator 17. The push notification generator 17 and the authentication system 18 may be configured such that authentication system 18 causes the push notification generator 17 to generate push notifications. Push notification generator 17 may generate push notifications responsive to instructions in push notification messages from authentication system 18. In some embodiments, the push notification messages from the authentication system 18 may be sent with an authentication token by which the push notification generator 17 determines whether an individual message is authorized.

In some embodiments, the push notification generator 17 is a consolidated push notification service. This means the push notification generator 17 may be utilized by each of the applications executed on the mobile computing device 12, for example. Among other advantages, this may save battery power in the mobile computing device 12 because each individual application executed on the mobile computing device is not required to register a current IP address (which may change frequently) with each different remote server (e.g., different application servers). Using a single push notification service such as the push notification generator 17 shared by the individual applications running on the mobile computing device 12 allows a single operating system to provide the service.

In some embodiments, the authentication system 18 may include a challenge generator 42, a validator 44, a user profile repository 46, and memory 48. In some embodiments, the challenge generator 42 and the validator 44 may be executed on one or more processor cores. In some embodiments, the user profile repository 46 may be stored in memory 48, which may include persistent storage and in-memory databases. In some embodiments, the authentication system 18 may include one or more servers and backend services executing on one or more computing devices, such as rack-mounted computing devices in a data center.

In some embodiments, the authentication system 18 may execute operations coordinated by the challenge generator 42, for example, responsive to communications from the mobile computing device 12, the client computing device 14, the application server 16, or the push notification generator 17. In some embodiments, the challenge generator 42 may receive a message from an application server 16 or the client computing device 14 indicating a user identifier and, in some cases, a user credential as part of an authentication request. In response, the challenge generator 42 may access the user profiles repository 52 to identify a user profile corresponding to the user identifier and, in some cases, validate that a user supplied password is correct.

The user profile repository 46 may be configured such that the profile of the user is associated with both a mobile computing device and a public cryptographic key of an asymmetric cryptographic process. In some embodiments, the public cryptographic key may comprise an exponent and a modulus of two prime numbers. In some embodiments, asymmetric cryptographic process comprises a post-quantum cryptographic process. In some embodiments, the mobile computing device 12 may store a record by which the mobile computing device 12 (e.g., processor 24 and/or native authentication application 30) accesses a private cryptographic camouflaged key corresponding to the public cryptographic key upon receiving a credential from the user. In some embodiments, the user profile repository stores more than 1000, 10000, 100000, or 1000000 user profiles for more than 1000, 10000, 100000, or 1000000 different users. In some embodiments, the credential may be entered into the mobile computing device 12 through the user interface 22 or other components of mobile computing device 12. The cryptographic keys may be generated upon installation and registration of the native authentication app 30, e.g., more than one day or one month before a given authentication session in which the keys are used.

In response to receiving the authentication request, the challenge generator 42 may be configured to access the profile of the user stored in user profile repository 46 based on the user identifier. The challenge generator 42 may be configured to retrieve an identifier of the mobile computing device 12 from the user profile and cause a push notification to be sent to the mobile computing device 12 using the identifier. In some embodiments, causing the push notification to be sent to the mobile computing device 12 includes sending a message to an application program interface of push notification generator 17.

In some embodiments, the push notification includes, or causes the mobile computing device 12 to retrieve from the authentication system 18 (e.g., by sending a URL from which it is retrieved), an authentication-session specific value. In some embodiments, the authentication-session specific value may have greater than 8 bits of entropy, 16 bits of entropy, 32 bits of entropy, 64 bits of entropy, or 128 bits of entropy. For instance, the value may be a randomly selected value from a name space with more than 2 to the power of 8, 16, 32, 64, or 128 distinct names. In some embodiments, the authentication-session specific value may be encoded as a string of alphanumeric characters, hex values, binary values, or the like. In some embodiments, the authentication-session specific value may be a random value, such as a pseudo randomly generated value based on a seed, a linear shift register, and a source of entropy. In some embodiments, the authentication-session specific value may be generated based on an output from an on-chip hardware random number generator taking as an input an on-chip source of entropy. In some embodiments, the challenge generator 42 may be configured to form, in memory 48 or in other locations, an authentication-session record that associates the authentication-session specific value with the push notification sent to the mobile computing device, such that returned responses from can be matched to the push notification and distinguished from prior sessions with the mobile device and sessions with other mobile devices.

The mobile computing device 12 may be configured to receive the push notification and the authentication-session specific value. The mobile computing device 12 may be configured to present a view of the user interface 22 configured to receive input of the credential from the user. In some embodiments, the credential from the user is an alphanumeric string of characters of a format selected to impose a manageable cognitive load on a user. In some embodiments, the credential from the user has less than or equal to 4, 8, 32, or 64 bits of entropy. In some embodiments, the credential from the user may be a person identification number (PIN) associated with the user, like a 6 or fewer digit numeric or alphanumeric code. In some embodiments, the credential from the user may be a biometric measurement of a biometric attribute of the user. For example, such biometric attributes may include fingerprints, facial structure, voice, eye characteristics, and/or other biometric attributes.

The mobile computing device 12 may be configured to transform, based on the credential from the user, the record by which the mobile computing device accesses the private cryptographic camouflaged key into the private cryptographic key. In some embodiments, prior to transforming, the private cryptographic key may be camouflaged in the memory 26 of the mobile computing device 12. This may make the private cryptographic camouflaged key inaccessible without the user credential. In some embodiments, transforming the record by which the mobile computing device 12 accesses the private cryptographic camouflage key into the private cryptographic key may comprise unmasking the private cryptographic camouflage key by executing an XOR operation (e.g., in which the user-supplied credential is repeated to match a bit-length of the record and combined with the stored record in a bit-wise XOR operation) and/or other operations based on both the credential from the user and the record by which the mobile computing device accesses the private cryptographic camouflage key. In some embodiments, the native authentication application 30 may be configured to access the record by which the mobile computing device 12 accesses the private cryptographic key via a hardware-based key manager of the mobile computing device 12. In some embodiments, the native authentication application 30 may execute on a different processor of the mobile computing device from a processor of the mobile computing device with access to the record by which the mobile computing device accesses the private cryptographic key. For instance, the record may be stored in a physically separate memory address space accessed via communication by interrupt with a secure element co-processor.

The mobile computing device 12 may be configured to cryptographically sign, with the de-camouflaged private cryptographic key, the authentication-session specific value or value based thereon. In some embodiments, cryptographically signing the authentication-session specific value or value based thereon comprises computing a cryptographic hash value based on the authentication-session specific value, and encrypting the cryptographic hash value with the de-camouflaged private cryptographic key to produce a ciphertext. Examples of cryptographic processes include RSA encryption, elliptic curve based encryption and various post-quantum techniques, like lattice-based encryption.

The above-described encryption at the application level should be distinguished from Transport Layer Security (TLS) and Secure Sockets Layer (SSL), which may underlie the above-described cryptographic processes. For instance, a ciphertext demonstrating possession of the authentication-session specific value and the private key may itself be encrypted with TLS or SSL encryption for transmission. But as noted above, TLS or SSL may be compromised in some cases if an improper root certificate is installed on the mobile device or if a brute force attack defeats this encryption, either one of which could leave an opening for a man-in-the-middle attack.

The mobile computing device 12 may be configured to cause one or more messages (like the ciphertext) to be sent via the network to the authentication system 18 that include both the identifier that identifies the mobile computing device 12 or an authentication session in which the push notification was sent, and the cryptographically signed value demonstrating possession of both the authentication-session specific value, the private cryptographic camouflaged key and the ability to de-camouflage the cryptographic camouflaged key. The challenge generator 42 may be configured to receive, from the mobile computing device 12 both the identifier that identifies the mobile computing device 12 or an authentication session in which the push notification was sent, and the cryptographically signed value demonstrating possession of both the authentication-session specific value and the private cryptographic key.

The validator 44 may be configured to authenticate the user by selecting, based on the identifier that identifies the mobile computing device 12 or an authentication session in which the push notification was sent, the authentication-session record from among a plurality of authentication-session records. In some embodiments, the authentication-session record is selected from among more than 10, 100, or 1000 different authentication-session records of concurrent authentication sessions for various users. In some embodiments, at least some of the plurality of authentication-session records correspond to other authentication sessions with other users. The validator 44 may be configured to access, from the selected authentication-session record, the authentication-session specific value or value based thereon.

The validator 44 may be configured to determine, based on both the public cryptographic key of the profile of the user and the authentication-session specific value or value based thereon, that the received cryptographically signed value correctly demonstrates possession of both the authentication-session specific value and the private cryptographic key. In some embodiments, determining that the received cryptographically signed value correctly demonstrates possession of both the authentication-session specific value and the private cryptographic key comprises decrypting the ciphertext with the public cryptographic key to access the cryptographic hash value computed by the mobile computing device 12. In some embodiments, this operation further comprises computing a cryptographic hash of the sent authentication-session specific value with the authentication system and determining a resulting cryptographic hash output matches the accessed cryptographic hash value computed by the mobile computing device. In some embodiments, transformed versions of the authentication-session specific value may be compared at the system 18 For instance, both the authentication system and the mobile computing device may store a shared secret, like a symmetric cryptographic key, and a cryptographic hash based on both the sent authentication-session specific value and the shared secret may be computed on both ends, sent from the mobile device in the above-described ciphertext, and compared to a locally computed hash value upon verifying the signature at the system 18.

In response to the determination to authenticate the user, the validator 44 may cause a message to be sent to the network-accessible application (e.g., provided by the application server 16) that causes the network-accessible application to grant access to the resources to the client computing device 14. In some embodiments, causing the message to be sent to the network-accessible application that causes the network-accessible application to grant access to the resources to the client computing device 14 includes sending an authentication token to the server 16 of the network-accessible application via a channel that passes through the client computing device 14 by sending a redirect command to a browser or a native authentication application 40 executing on the client computing device 14. In some embodiments, the redirect command may include both a uniform resource locator of the server 16 of the network-accessible application and the authentication token. In some embodiments, the communication between the validator 44 and the application server 16 may occur via a back channel established directly between the validator 44 and the application server 16.

In some embodiments, the native authentication application 30 does not provide an indication to the user of whether the credential from the user supplied via user interface 22 is correct before causing the message to be sent from mobile computing device 12. In some embodiments, the authentication system 18 (e.g., validator 44) may be configured to increment a count of failed authentication attempts, determine that the count exceeds a threshold, and deny authentication regardless of whether a correct credential from the user is provided after determining that the count exceeds a threshold.

In some embodiments, the user profiles repository 46 may store a plurality of user profiles, for example in a relational or noSQL database. In some embodiments, each user profile may include a user identifier for a given user on a given application server 16, or in some cases, the same user identifier may be shared across multiple application servers 16 posting multiple web applications or other application program interfaces. In some embodiments, each of these user identifiers may be associated with a corresponding knowledge factor credential, like a password or other value by which a user demonstrates possession of the knowledge factor credential (e.g., a salted cryptographic hash of a password). In some embodiments, the user profiles include computing device profiles, for example for a given user, corresponding to the client computing device 14 and the mobile computing device 12. In some embodiments, each user profile may include one or more, for example two, three, five or more computing device profiles, e.g., 2, 3, 5 or more. In some cases, each computing device profile may include the information by which a configuration of hardware and software on a computing device may be fingerprinted. In some cases, the profiles may include device-specific tokens sent with push notifications to generator 17 to authentication the push notification to the respective device and otherwise protect devices from unwanted, unauthorized notifications.

Upon a user not being authenticated, in some embodiments, the application server 16 may decline to provide access to the requested resources by the client computing device, in some cases providing an indication of why access was not granted may be provided, for example, indicating that a user did not demonstrate possession of mobile computing device 12 or the private cryptographic key.

Alternatively, upon a user being granted access, for instance upon the user supplying the appropriate user identifier, knowledge factor credential, and demonstrating possession of the mobile computing device 12, the authentication-session specific value, and the private cryptographic key, the application server 16 may then provide access to the requested resources, for instance by sending subsequent user interface views including information that would not otherwise be available and responding to subsequent commands, like various queries from the client computing device 14. In some embodiments, the client computing device may be sent an authentication token that may be included in subsequent exchanges in a given authenticated session to indicate to the application server 16 that the subsequent request is part of an authentication's authenticated session. In some embodiments, when responding to subsequent requests, the application server 16 may validate that the subsequent request is associated with a valid authentication token. In some embodiments, these authentication tokens may be expired by the application servers 16 and cease to be honored, for instance after a given session ends or after a threshold amount of time has elapsed, in which case, the user may be forced to seek re-authentication with the techniques described above.

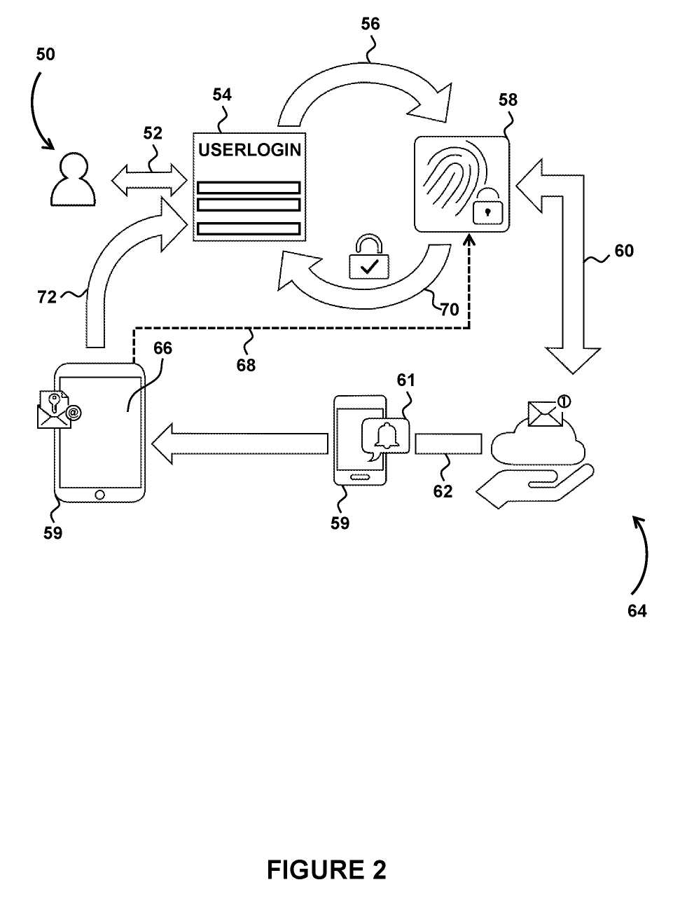

By way of a non-limiting example (which is not to suggest that other examples are limiting), FIG. 2 is a flowchart illustrating a practical use case that includes operations of the authentication process described above with respect to the computing environment shown in FIG. 1. As shown in FIG. 2, a user 50 (by operation of a user computing device) may attempt to access 52 resources of a network-accessible application (e.g., hosted by an application server similar to or the same as application server 16 shown in FIG. 1) protected by the push notification authentication operations described herein. In the example shown in FIG. 2, the resources of a network-accessible application may be associated with an web-based email account (though the present techniques are expected to be useful for protecting other web applications, like industrial-controls portal websites, banking websites, document hosting websites, social media websites, and the like). In some embodiments, the application server of the web-based email site may be configured to send a view 54 of a user interface to a client computing device of the user 50 after receiving a request to access resources. The view 54 may request a user identifier from the user 50 and a password. It should be noted that the description of the web-based email site 54 is not intended to be limiting (which is not to suggest that other descriptions are limiting). The web-based email site 54 may be representative of a variety of different resources of a network-accessible application. The application server may request 56 authentication from an authentication system 58 (e.g., similar to or the same as authentication system 18 shown in FIG. 1) to determine whether to grant access to user 50. The user identifier may identify a profile of the user 50. In the profile, the user 50 may be associated with both a mobile computing device 59 (e.g., similar to or the same as mobile computing device 12 shown in FIG. 1) and a public cryptographic key of an asymmetric cryptographic process. The mobile computing device 59 may store a record by which the mobile computing device accesses a private cryptographic key corresponding to the public cryptographic key upon receiving a credential (e.g., a personal identification number, a biometric identifier such as a finger print, and/or other credentials) from the user 50.

Responsive to receiving the authentication request, authentication system 58 may cause 60 a push notification 61 to be sent 62 to the mobile computing device 59 of the user 50 from a push notification generator 64 (e.g., similar to or the same as push notification generator 17 shown in FIG. 1). The push notification may comprise an authentication-session specific value such as a random string (in this example). The authentication-session specific value may be associated with the mobile computing device in an authentication-session record. For example, the push notification may include one or more device identifications with the random string (e.g., DeviceID, Random String, DeviceID) The mobile computing device 59 may, in return, communicate both an identifier that identifies the mobile computing device 59 or an authentication session in which the push notification was sent, and a cryptographically signed value demonstrating possession of both the authentication-session specific value and the private cryptographic key. For example, upon receiving the push notification, a native authentication application may control a user interface 66 (e.g., similar to or the same as user interface 22 and native authentication application 30 shown in FIG. 1) of the mobile computing device 59 to require the user 50 to enter a credential (e.g., a PIN, a fingerprint, etc.) to open the push notification and cause, in the background, the native authentication application to de-camouflage the private key (which is not to suggest that the private key needs to be displayed), sign the authentication-session specific value, and send 68 it to the authentication system 58 for verification. The user 50 may be authenticated 70 by, among other operations, the authentication system 58 determining, based on both the public cryptographic key of the profile of the user 50 and the authentication-session specific value, that the received cryptographically signed value correctly demonstrates possession of the mobile computing device 59, the authentication-session specific value, and the private cryptographic key. Once authenticated 70, the application server may grant access 72 to the user 50 to the resources of the network-accessible application. In some embodiments, the private key may be camouflaged and de-camouflaged based on a PIN code supplied by the user with the techniques described in U.S. Pat. No. 6,170,058, titled “Method and apparatus for cryptographically camouflaged cryptographic key storage, certification and use,” the contents of which are hereby incorporated by reference. In some embodiments, a key wallet stores the private key in encrypted form, where the encryption key is the user's PIN. In some embodiments, the ciphertext of the private key may be decrypted with the user's PIN, and the revealed private key may be used to cryptographically sign a random string or other high-entropy challenge sent from the authentication system.

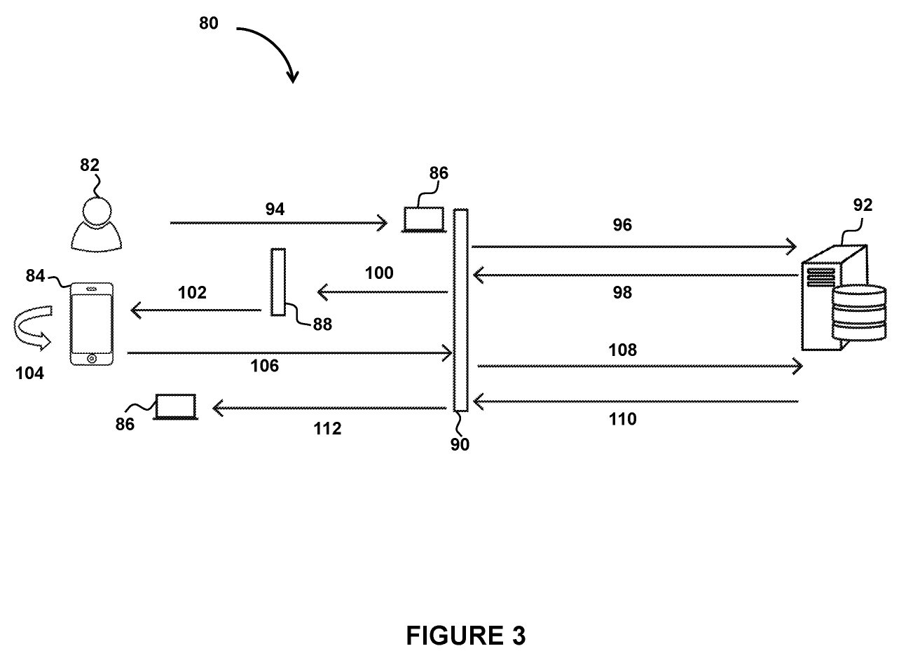

FIG. 3 shows an example of a process 80 that may be implemented in the computing environment of FIG. 1, but which is not limited to that implementation, which is not to suggest that any other description herein is limiting. In some embodiments, the functionality of the process of FIG. 3, and the other functionality described herein may be implemented by storing program code on a tangible, non-transitory, machine-readable medium, such that when the instructions in the program code are executed by one or more processors, the described functionality is effectuated. In some cases, different subsets of the program code may be stored on different instances of media, for instance on different computing devices the execute different subsets of the instructions, an arrangement that is consistent with the use of the singular term “medium” as used herein. In some embodiments, the described operations may be executed in a different order, may be replicated, may be executed sequentially, may be executed concurrently, may be omitted, may be replicated, or may be otherwise differently arranged from that shown in FIG. 3, which is not to suggest that any other description is limiting.

In this example, one human entity, user 82, is shown as participating in the process (via two different computing devices) along with different computing device entities including a mobile computing device 84, a web browser (for example) on another computing device 86 different from the mobile computing device 84, a push notification generator 88, a representational state transfer (REST) or web services (WS) interface 90 (e.g., which may be a standalone system, or may be associated with one or more of the devices shown in FIG. 3, or an application server similar to or the same as application server 16 shown in FIG. 1), and an authentication system 92. In some embodiments, the user 82 may be a user of the computing devices 12 and 14 described above with reference to FIG. 1. In some embodiments, the mobile computing device 84 may be the mobile computing device 12. In some embodiments, the computing device 86 may be the client computing device 14 described above, and the browser may be the web browser or native authentication application 40 described above. In some embodiments, the push notification generator 88 may be the push notification generator 17 described above with respect to FIG. 1. In some embodiments, the authentication system 92 is the authentication system 18 of FIG. 1.

In some embodiments, the process 80 begins with the user 82 interacting with the browser on the computing device 86 to request access to resources available remotely over a network, as indicated by authentication request communication 94, which in some cases may include a user selecting a link or navigating the web browser in some other fashion. In some cases, as described above, the role of the browser may be filled by a native application that accesses a remote application program interface. The communication 94 may be received by REST / WS interface 90 and, in turn, communicated 96 to the authentication system 92. In some embodiments, in response to the user's request, the browser and/or the computing device 86 may request access to the resources, for instance, by sending a get request to an Internet protocol address of an application server indicated by a domain name service as corresponding to a specified uniform resource locator.

In some cases, upon receiving the request for access, the interface 90 and/or an associated application server may determine whether the request is associated with a currently authenticated session with the browser running on computing device 86. In some cases, this may include determining whether an authentication token is appended to the request 94, for instance as a query parameter, and determining that such an appended authentication token corresponds to a valid authenticated session, such as one that is not been expired, and corresponds to a list of authentication tokens that are valid stored by interface 90 or in memory of the application server. Upon determining that the request for access 94 is associated with an already authenticated session, in some cases, the interface 90 may send the requested resources, such as webpage content, files, application program interface request responses, or the like, back to the application executing client-side, such as the browser. In the illustrated example, the request for access 94 is not part of a currently authenticated session. In response, interface 90 and/or an associated application server may respond by sending instructions to the computing device 86 that cause the browser to display a user interface by which the user 82 may enter a user identifier and various user credentials. In the illustrated example, the user 82 may request access to the resources by entering their user identifier and credentials into an initial user interface sent by the interface 90 and/or an associated application server. For instance, the user 82 may enter a username and password, or allow various biometric attributes of the user 82 to be scanned or otherwise submitted.

In some embodiments, the interface 90 may then establish a back channel of communication with the authentication system 92 and request authentication of the user 82 in communication 96 based on the supplied identifier and credentials. In some cases, the interface 90 and/or an associated application server may be configured to hand off the entire authentication process to the authentication system 92 without establishing a back channel of communication. An example of such is by implementing an OAuth protocol, such as in the OAuth 2.0 specification. In some embodiments, the communication 96 request to authenticate the user 82 may include one or more the attributes described by which the computing device 86 executing the browser may be profiled. Examples of such may include parameters in a user agent string in a hypertext transport protocol request from the browser to the interface 90, or various other parameters gathered by a native application by querying an application and an operating system interface executing on the client device 86 running the browser.

In some embodiments, the communication 96 from the interface 90 and computing device 86 may indicate the user identifier and, in some cases, a user credential as part of an authentication request. In response, the authentication system 92 may access a user profiles repository (e.g., as described above) to identify a user profile corresponding to the user identifier and, in some cases, validate that a user supplied password is correct. The user profile repository may be configured such that the profile of the user 82 is associated with both the mobile computing device 84 and a public cryptographic key of an asymmetric cryptographic process. In some embodiments, the mobile computing device 84 may store a record by which the mobile computing device 84 accesses a private cryptographic key corresponding to the public cryptographic key upon receiving a credential from the user (e.g., as described below).

In some embodiments, the authentication system 92 may determine whether the supplied identifier and credentials, or values demonstrating possession thereof, correspond to values in the user profile, for instance, determining whether the user 82 has demonstrated that they are in possession of a password associated with the user identifier in the user profile. Some embodiments may further determine whether a computing device profile of the computing device 86 executing the browser matches a profile of a computing device stored in the user profile matching the user identifier.

The authentication system 92 may be configured to retrieve an identifier of the mobile computing device 84 from the user 82 profile and cause a communication 98 to be sent to interface 90 that requests a push notification be sent to the mobile computing device 84 of the user 82. Interface 90 may, in turn, send a communication 100 to the push notification generator 88 requesting the push notification be communicated 102 to mobile computing device 84. In some embodiments, communications 98, 100, and 102 may be configured such that the push notification comprises an authentication-session specific value such as a random string or other values. In some embodiments, the authentication-session specific value may be associated with the mobile computing device 84 in an authentication-session record. In some embodiments, the authentication system 92 may be configured to form this authentication-session record in memory, for example.

The mobile computing device 84 may be configured to receive the push notification communication 102 including the authentication-session specific value. The mobile computing device 84 may be configured to present a view of a user interface configured to receive input of a credential from the user 82. In some embodiments, the credential from the user may be an alphanumeric string of characters such as a PIN associated with the user, a biometric measurement of a biometric attribute of the user, and/or other credentials. In some embodiments, as described above, the private cryptographic key may be inaccessible without the user credential. The mobile computing device 84 may be configured to cryptographically sign 104, with the private cryptographic key, the authentication-session specific value.

The mobile computing device 84 may be configured to cause a communication 106 to be sent via the network to the interface 90 which, in turns, sends a communication 108 to the authentication system 92 that include both the identifier that identifies the mobile computing device 84 or an authentication session in which the push notification was sent, and the cryptographically signed value demonstrating possession of both the authentication-session specific value and the private cryptographic key.

The authentication system 92 may be configured to receive communication 108 and authenticate the user 82 by selecting, based on the identifier that identifies the mobile computing device 84 or an authentication session in which the push notification was sent, the authentication-session record from among a plurality of authentication-session records. The authentication system 92 may be configured to access, from the selected authentication-session record, the authentication-session specific value. The authentication system 92 may be configured to determine, based on both the public cryptographic key of the profile of the user 82 and the authentication-session specific value, that the received cryptographically signed value in communication 108 correctly demonstrates possession of both the authentication-session specific value and the private cryptographic key.

In response to the determination to authenticate the user, the authentication system 92 may cause a communication 110 to be sent to the interface 90 that, in turn, sends a communication 112 to computing device 86 that causes access to the resources to be granted to the computing device 86. For example, upon determining that the communication 108 contains sufficient information to demonstrate a completed authentication process, some embodiments may send a message 110 to the interface 90 indicating that the user 82 operating the browser and/or the computing device 86 is authenticated, or a communication indicating that the user is not authenticated if the values do not match. Responsive to this communication 110, the interface 90 and/or an associated application server may determine whether to signal to the computing device 86 that the authentication was successful, as indicated by communication 112. In some cases, the mobile computing device 84 or the computing device 86 may provide indication to the user 82 responsive to this communication indicating a result. In some embodiments, upon a failed authentication, the interface 90 and/or the associated application server may decline to provide the access requested in communication 94. Alternatively, upon determining that the authentication attempt was successful, the interface 90 and/or the associated application server may provide access to various remotely hosted resources to the browser or other native application running on computing device 86, for instance various software as a service web applications or various remotely hosted application program interfaces by which one or more databases may be accessed to retrieve data or write data with the computing device 86 executing the browser.

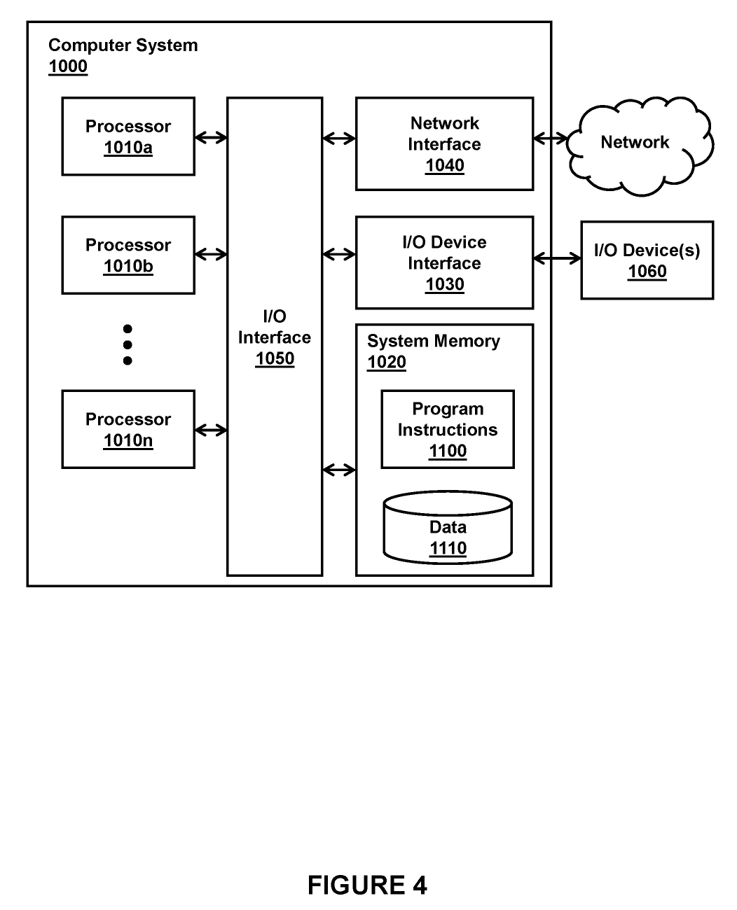

FIG. 4 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to Y,” “upon Y,”, “if Y,” “when Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing _{X} performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:
1. A method, comprising: receiving, with one or more processors of an authentication system, via a network, a request to authenticate a user attempting to access resources of a network-accessible application with a client computing device; receiving, with one or more processors of the authentication system, from the client computing device, via the network, a user identifier that is associated with the request, wherein: the user identifier identifies a profile of the user, in the profile, the user is associated with both a mobile computing device and a public cryptographic key of an asymmetric cryptographic process, and the mobile computing device stores a record by which the mobile computing device accesses a private cryptographic key corresponding to the public cryptographic key upon receiving a credential from the user; in response to receiving the request, accessing, with one or more processors of the authentication system, the profile of the user based on the user identifier and retrieving an identifier of the mobile computing device; causing, with one or more processors of the authentication system, based on the identifier of the mobile computing device, a push notification to be sent to the mobile computing device, wherein: the push notification comprises, or causes the mobile computing device to retrieve from the authentication system, an authentication-session specific value with greater than 32 bits of entropy; forming, in memory, with one or more processors of the authentication system, an authentication-session record that associates the authentication-session specific value with the mobile computing device; receiving, with one or more processors of the authentication system, from the mobile computing device both: an identifier that identifies the mobile computing device or an authentication session in which the push notification was sent, and a cryptographically signed value demonstrating possession of both the authentication-session specific value and the private cryptographic key; determining, with one or more processors of the authentication system, to authenticate the user by: selecting, based on the identifier that identifies the mobile computing device or an authentication session in which the push notification was sent, the authentication-session record from among a plurality of authentication-session records, at least some of which correspond to other authentication sessions with other users; accessing, from the selected authentication-session record, the authentication-session specific value or value based thereon with greater than 32 bits of entropy; determining, based on both the public cryptographic key of the profile of the user and the authentication-session specific value or value based thereon, that the received cryptographically signed value correctly demonstrates possession of both the authentication-session specific value and the private cryptographic key; and in response to the determination to authenticate the user, causing, with one or more processors of the authentication system, a message to be sent to the network-accessible application that causes the network-accessible application to grant access to the resources to the client computing device.
2. The method of embodiment 1, further comprising: receiving, with one or more processors of the mobile computing device executing a native authentication application, the push notification and the authentication-session specific value; presenting, with one or more processors of the mobile computing device, a user interface configured to receive input of the credential from the user and receiving the credential from the user via the user interface; transforming, with one or more processors of the mobile computing device, based on the credential from the user, the record by which the mobile computing device accesses the private cryptographic key into the private cryptographic key, wherein prior to transforming, the private cryptographic key is obfuscated in memory of the mobile computing device making the private cryptographic key inaccessible without the user credential; and cryptographically signing, with one or more processors of the mobile computing device, with the private cryptographic key, the authentication-session specific value or value based thereon with greater than 32 bits of entropy; and causing, with one or more processors of the mobile computing device, one or more messages to be sent via the network to the authentication system that include both: the identifier that identifies the mobile computing device or an authentication session in which the push notification was sent, and the cryptographically signed value demonstrating possession of both the authentication-session specific value and the private cryptographic key.
3. The method of embodiment 2, wherein transforming the record by which the mobile computing device accesses the private cryptographic key into the private cryptographic key comprises: unmasking the private cryptographic key by executing an XOR operation based on both the credential from the user and the record by which the mobile computing device accesses the private cryptographic key.
4. The method of embodiment 2 or 3, wherein: cryptographically signing the authentication-session specific value or value based thereon with greater than 32 bits of entropy comprises: computing a cryptographic hash value based on the authentication-session specific value; and encrypting the cryptographic hash value with the private cryptographic key to produce a ciphertext; and determining that the received cryptographically signed value correctly demonstrates possession of both the authentication-session specific value and the private cryptographic key comprises: decrypting the ciphertext with the public cryptographic key to access the cryptographic hash value computed by the mobile computing device; and computing a cryptographic hash of the sent authentication-session specific value with the authentication system and determining a resulting cryptographic hash output matches the accessed cryptographic hash value computed by the mobile computing device.
5. The method of any of embodiments 1-4, wherein: the authentication system manages more than 1000 user profiles; the authentication-session record is selected from among more than 10 of authentication-session records of concurrent authentication sessions; the authentication-session specific value has greater than 128 bits of entropy; and the credential from the user has less than or equal to 64 bits of entropy.
6. The method of embodiment 5, wherein: the credential from the user is a person identification number (PIN) associated with the user.
7. The method of embodiment 5, wherein: the credential from the user is a biometric measurement of a biometric attribute of the user.
8. The method of embodiment 5, wherein: the native application does not provide an indication to the user of whether the credential from the user is correct before causing the message to be sent; and the authentication system is configured to increment a count of failed authentication attempts, determine that the count exceeds a threshold, and deny authentication regardless of whether a correct credential from the user is provided after determining that the count exceeds a threshold.
9. The method of embodiment 2, wherein: the native application is configured to access the record by which the mobile computing device accesses the private cryptographic key via a hardware-based key manager of the mobile computing device; and the native application executes on a different processor of the mobile computing device from a processor of the mobile computing device with access to the record by which the mobile computing device accesses the private cryptographic key.
10. The method of any of embodiments 1-9, wherein the public cryptographic key comprises an exponent and a modulus of two prime numbers.
11. The method of any of embodiments 1-10, wherein: asymmetric cryptographic process comprises a post-quantum cryptographic process. 12. The method of any of embodiments 1-11, wherein: the authentication-session specific value is generated based on an output from an on-chip hardware random number generator taking as an input an on-chip source of entropy.
13. The method of any of embodiments 1-12, wherein: causing the message to be sent to the network-accessible application that causes the network-accessible application to grant access to the resources to the client computing device comprises: sending an authentication token to a server of the network-accessible application via a channel that does not pass through the client computing device.
14. The method of any of embodiments 1-13, wherein: causing the message to be sent to the network-accessible application that causes the network-accessible application to grant access to the resources to the client computing device comprises: sending an authentication token to a server of the network-accessible application via a channel that passes through the client computing device by sending a redirect command to a browser executing on the client computing device, the redirect command including both a uniform resource locator of the server of the network-accessible application and the authentication token.
15. The method of any of embodiments 1-14, wherein causing a push notification to be sent to the mobile computing device comprises: sending a message to an application program interface of a remote push notification service, wherein: push notification service provides push notification for more than 100 different native applications by more than 100 different native-application developers; a native authentication application executing on the mobile computing device has previously registered the mobile computing device with the push notification service; and the message is sent with an authentication token by which the push notification service determines whether the message is authorized.
16. The method of any of embodiments 1-15, the operations comprising: steps for authenticating a user to access resources.
17. A tangible, non-transitory, machine-readable medium of an authentication system storing instructions that when executed by one or more processors effectuate operations comprising: the operations of any of embodiments 1-16.
18. A system, comprising: one or more processors; and memory storing instructions that when executed by at least some of the processors effectuate operations comprising: the operations of any of embodiments 1-16.

What is claimed is:

1. A method, comprising:
receiving, with one or more processors of an authentication system, via a network, a request to authenticate a user attempting to access resources of a network-accessible application with a client computing device;
receiving, with one or more processors of the authentication system, from the client computing device, via the network, a user identifier that is associated with the request, wherein:
the user identifier identifies a profile of the user,
in the profile, the user is associated with both a mobile computing device and a public cryptographic key of an asymmetric cryptographic process, and
the mobile computing device stores a record by which the mobile computing device accesses a private cryptographic key corresponding to the public cryptographic key upon receiving a credential from the user;
in response to receiving the request, accessing, with one or more processors of the authentication system, the profile of the user based on the user identifier and retrieving an identifier of the mobile computing device;
causing, with one or more processors of the authentication system, based on the identifier of the mobile computing device, a push notification to be sent to the mobile computing device, wherein:
the push notification comprises, or causes the mobile computing device to retrieve from the authentication system, an authentication-session specific value with greater than 32 bits of entropy;
forming, in memory, with one or more processors of the authentication system, an authentication-session record that associates the authentication-session specific value with the mobile computing device;
receiving, with one or more processors of the authentication system, from the mobile computing device both:
an identifier that identifies the mobile computing device or an authentication session in which the push notification was sent, and
a cryptographically signed value demonstrating possession of both the authentication-session specific value and the private cryptographic key;
determining, with one or more processors of the authentication system, to authenticate the user by:
selecting, based on the identifier that identifies the mobile computing device or an authentication session in which the push notification was sent, the authentication-session record from among a plurality of authentication-session records, at least some of which correspond to other authentication sessions with other users;
accessing, from the selected authentication-session record, the authentication-session specific value or value based thereon with greater than 32 bits of entropy;
determining, based on both the public cryptographic key of the profile of the user and the authentication-session specific value or value based thereon, that the received cryptographically signed value correctly demonstrates possession of both the authentication-session specific value and the private cryptographic key; and
in response to the determination to authenticate the user, causing, with one or more processors of the authentication system, a message to be sent to the network-accessible application that causes the network-accessible application to grant access to the resources to the client computing device.

2. The method of claim 1, further comprising:
receiving, with one or more processors of the mobile computing device executing a native authentication application, the push notification and the authentication-session specific value;
presenting, with one or more processors of the mobile computing device, a user interface configured to receive input of the credential from the user and receiving the credential from the user via the user interface;
transforming, with one or more processors of the mobile computing device, based on the credential from the user, the record by which the mobile computing device accesses the private cryptographic key into the private cryptographic key, wherein prior to transforming, the private cryptographic key is obfuscated in memory of the mobile computing device making the private cryptographic key inaccessible without the user credential; and
cryptographically signing, with one or more processors of the mobile computing device, with the private cryptographic key, the authentication-session specific value or value based thereon with greater than 32 bits of entropy; and
causing, with one or more processors of the mobile computing device, one or more messages to be sent via the network to the authentication system that include both:
the identifier that identifies the mobile computing device or an authentication session in which the push notification was sent, and
the cryptographically signed value demonstrating possession of both the authentication-session specific value and the private cryptographic key.

3. The method of claim 2, wherein transforming the record by which the mobile computing device accesses the private cryptographic key into the private cryptographic key comprises:
unmasking the private cryptographic key by executing an XOR operation based on both the credential from the user and the record by which the mobile computing device accesses the private cryptographic key.

4. The method of claim 2, wherein:
cryptographically signing the authentication-session specific value or value based thereon with greater than 32 bits of entropy comprises:
computing a cryptographic hash value based on the authentication-session specific value; and
encrypting the cryptographic hash value with the private cryptographic key to produce a ciphertext; and
determining that the received cryptographically signed value correctly demonstrates possession of both the authentication-session specific value and the private cryptographic key comprises:
decrypting the ciphertext with the public cryptographic key to access the cryptographic hash value computed by the mobile computing device; and
computing a cryptographic hash of the sent authentication-session specific value with the authentication system and determining a resulting cryptographic hash output matches the accessed cryptographic hash value computed by the mobile computing device.

5. The method of claim 1, wherein:
the authentication system manages more than 1000 user profiles;
the authentication-session record is selected from among more than 10 of authentication-session records of concurrent authentication sessions;
the authentication-session specific value has greater than 128 bits of entropy; and
the credential from the user has less than or equal to 64 bits of entropy.

6. The method of claim 5, wherein:
the credential from the user is a person identification number (PIN) associated with the user; and
the record by which the mobile computing device accesses the private cryptographic key is a camouflaged private cryptographic key that is de-camouflaged with the PIN to afford access by the mobile computing device to the private cryptographic key.

7. The method of claim 5, wherein:
the credential from the user is a biometric measurement of a biometric attribute of the user.

8. The method of claim 5, wherein:
the native application does not provide an indication to the user of whether the credential from the user is correct before causing the message to be sent; and
the authentication system is configured to increment a count of failed authentication attempts, determine that the count exceeds a threshold, and deny authentication regardless of whether a correct credential from the user is provided after determining that the count exceeds a threshold.

9. The method of claim 2, wherein:
the native application is configured to access the record by which the mobile computing device accesses the private cryptographic key via a hardware-based key manager of the mobile computing device; and
the native application executes on a different processor of the mobile computing device from a processor of the mobile computing device with access to the record by which the mobile computing device accesses the private cryptographic key.

10. The method of claim 1, wherein the public cryptographic key comprises an exponent and a modulus of two prime numbers.

11. The method of claim 1, wherein:
asymmetric cryptographic process comprises a post-quantum cryptographic process.

12. The method of claim 1, wherein:
the authentication-session specific value is generated based on an output from an on-chip hardware random number generator taking as an input an on-chip source of entropy.

13. The method of claim 1, wherein: causing the message to be sent to the network-accessible application that causes the network-accessible application to grant access to the resources to the client computing device comprises:
sending an authentication token to a server of the network-accessible application via a channel that does not pass through the client computing device.

14. The method of claim 1, wherein: causing the message to be sent to the network-accessible application that causes the network-accessible application to grant access to the resources to the client computing device comprises:
sending an authentication token to a server of the network-accessible application via a channel that passes through the client computing device by sending a redirect command to a browser executing on the client computing device, the redirect command including both a uniform resource locator of the server of the network-accessible application and the authentication token.

15. The method of claim 1, wherein causing a push notification to be sent to the mobile computing device comprises:
sending a message to an application program interface of a remote push notification service, wherein:
push notification service provides push notification for more than 100 different native applications by more than 100 different native-application developers;
a native authentication application executing on the mobile computing device has previously registered the mobile computing device with the push notification service; and
the message is sent with an authentication token by which the push notification service determines whether the message is authorized.

16. The method of claim 1, the operations comprising:
steps for authenticating a user to access resources.

17. A tangible, non-transitory, machine-readable medium of an authentication system storing instructions that when executed by one or more processors effectuate operations comprising:
receiving, with one or more processors of an authentication system, via a network, a request to authenticate a user attempting to access resources of a network-accessible application with a client computing device;
receiving, with one or more processors of the authentication system, from the client computing device, via the network, a user identifier that is associated with the request, wherein:
the user identifier identifies a profile of the user,
in the profile, the user is associated with both a mobile computing device and a public cryptographic key of an asymmetric cryptographic process, and
the mobile computing device stores a record by which the mobile computing device accesses a private cryptographic key corresponding to the public cryptographic key upon receiving a credential from the user;
in response to receiving the request, accessing, with one or more processors of the authentication system, the profile of the user based on the user identifier and retrieving an identifier of the mobile computing device;
causing, with one or more processors of the authentication system, based on the identifier of the mobile computing device, a push notification to be sent to the mobile computing device, wherein:
the push notification comprises, or causes the mobile computing device to retrieve from the authentication system, an authentication-session specific value with greater than 32 bits of entropy;
forming, in memory, with one or more processors of the authentication system, an authentication-session record that associates the authentication-session specific value with the mobile computing device;
receiving, with one or more processors of the authentication system, from the mobile computing device both:
an identifier that identifies the mobile computing device or an authentication session in which the push notification was sent, and
a cryptographically signed value demonstrating possession of both the authentication-session specific value and the private cryptographic key;
determining, with one or more processors of the authentication system, to authenticate the user by:
selecting, based on the identifier that identifies the mobile computing device or an authentication session in which the push notification was sent, the authentication-session record from among a plurality of authentication-session records, at least some of which correspond to other authentication sessions with other users;
accessing, from the selected authentication-session record, the authentication-session specific value or value based thereon with greater than 32 bits of entropy;
determining, based on both the public cryptographic key of the profile of the user and the authentication-session specific value or value based thereon, that the received cryptographically signed value correctly demonstrates possession of both the authentication-session specific value and the private cryptographic key; and
in response to the determination to authenticate the user, causing, with one or more processors of the authentication system, a message to be sent to the network-accessible application that causes the network-accessible application to grant access to the resources to the client computing device.

18. The medium of claim 17, the operations further comprising:
receiving, with one or more processors of the mobile computing device executing a native authentication application, the push notification and the authentication-session specific value;
presenting, with one or more processors of the mobile computing device, a user interface configured to receive input of the credential from the user and receiving the credential from the user via the user interface;
transforming, with one or more processors of the mobile computing device, based on the credential from the user, the record by which the mobile computing device accesses the private cryptographic key into the private cryptographic key, wherein prior to transforming, the private cryptographic key is obfuscated in memory of the mobile computing device making the private cryptographic key inaccessible without the user credential; and
cryptographically signing, with one or more processors of the mobile computing device, with the private cryptographic key, the authentication-session specific value or value based thereon with greater than 32 bits of entropy; and
causing, with one or more processors of the mobile computing device, one or more messages to be sent via the network to the authentication system that include both:
the identifier that identifies the mobile computing device or an authentication session in which the push notification was sent, and
the cryptographically signed value demonstrating possession of both the authentication-session specific value and the private cryptographic key.

19. The medium of claim 18, wherein:
cryptographically signing the authentication-session specific value or value based thereon with greater than 32 bits of entropy comprises:
computing a cryptographic hash value based on the authentication-session specific value; and
encrypting the cryptographic hash value with the private cryptographic key to produce a ciphertext; and
determining that the received cryptographically signed value correctly demonstrates possession of both the authentication-session specific value and the private cryptographic key comprises:
decrypting the ciphertext with the public cryptographic key to access the cryptographic hash value computed by the mobile computing device; and
computing a cryptographic hash of the sent authentication-session specific value with the authentication system and determining a resulting cryptographic hash output matches the accessed cryptographic hash value computed by the mobile computing device.

20. The medium of claim 18, wherein:
the native application does not provide an indication to the user of whether the credential from the user is correct before causing the message to be sent; and
the authentication system is configured to increment a count of failed authentication attempts, determine that the count exceeds a threshold, and deny authentication regardless of whether a correct credential from the user is provided after determining that the count exceeds a threshold.
